(19) United States
(12) Patent Application Publication
(10) Pub. No.: US 2012/0320179 A1
(43) Pub. Date: Dec. 20, 2012

(54) SYSTEM AND METHOD FOR LOCATION-MERGING OF IMAGE WITH HUMAN VISION USING TRANSPARENT DISPLAY

(76) Inventors: Karl Im, Burlingame, CA (US); Gary Rosensteel, McMurray, PA (US); Frederick Rezaei, Phoenix, AZ (US)

(21) Appl. No.: 13/525,987

(22) Filed: Jun. 18, 2012

Related U.S. Application Data
(60) Provisional application No. 61/497,692, filed on Jun. 16, 2011.

(51) Int. Cl. H04N 7/18

(52) U.S. Cl. 348/77; 348/E07.085

(57) ABSTRACT

We provide a device for combining tomographic images with human vision using a partially transparent display to merge the visual outer surface of an object with a simultaneous tomographic image from the interior of the object. The device may be used with various types of image modalities including ultrasound, CT, and MRI. The image captured device and the display may or may not be fixed to each other. If not fixed, the imaging device may provide a compensation device that adjusts the image on the partially transparent display to account for any change in the image capture device orientation or location. Methods for using such a device are also provided.

### CROSS-REFERENCE TO RELATED APPLICATIONS

This application claims priority to U.S. Provisional Patent Application No. 61/497,692, filed on Jun. 16, 2011, and incorporated by reference herein.

### BACKGROUND OF THE INVENTION

1. Field of the Invention

Embodiments of the invention are typically in the field of medical viewing technology and associated methods.

2. Background of the Related Art

Often during medical procedures it is beneficial for a practitioner to view the interior of a patient's body without the need for an incision. A number of viewing technologies exist, including CT, ultrasound, MRI, and other tomographic (slice-based) technologies. Typically these technologies use a detection device connected to a remote viewscreen for reviewing the results obtained by the detection device; typically this remote viewscreen is a monitor or other cart-mounted display. Unfortunately, there are many situations where such an arrangement is not advantageous. For example, having a screen that is remote from the actual imaging device means that a practitioner is not able to directly view the patient while also moving the imaging device and viewing the results.

A viewing technology has been developed that permits viewing of a target portion of a patient at the same time that the output of an imaging device is viewed. This is as shown, for example, in U.S. Pat. No. 6,599,247, which is incorporated by reference herein. In the '247 patent a tomographic image is created that uses a half-silvered mirror to merge the visual outer surface of an object with a simultaneous reflection of a tomographic image from the interior of the object. The tomographic image is displayed either on LCD or OLED and reflected on to the surface of the half-silvered mirror to create a heads-up display effect. This has the beneficial effect of allowing a physician or technician to view the image in the context of the object that is being reviewed.

Unfortunately, the method and apparatus reported in the '247 patent may have certain disadvantages in some situations. For example, when used in some sterile medical environments, the device should be provided as sterile and discarded after use. Replacement of all or part the device, particularly the mirror, can be expensive over the course of many uses of a procedure incorporating such a device.

In the alternative a device may be placed in a sterile wrapper, with the wrapper disposed of after use. Although this method is preferable from a cost-containment perspective, it does not present an ideal situation for use of the device; the enclosure of the mirror and/or LCD/OLED may, in some circumstances, limit or otherwise degrade the performance of the device. Enclosure with a sufficiently large sterile bag may be difficult. Furthermore, some difficulties may arise if the mirror and the LCD/OLED are not correctly aligned or fall out of alignment. This may particularly be the case if the viewing angle is very high, which might prevent accurate reflection and reproduction of the image on the mirror.

### BRIEF SUMMARY OF THE INVENTION

Embodiments of the invention may provide an imaging and display device including an image capture device for capturing at least one image of the internal structure of a target object, a display for displaying a captured image (either a single image or a real-time flow of images) from the image capture device; and a transparent or partially transparent display screen displaying the captured image oriented to an operator of the imaging device such that a captured image is merged with a direct view of the target object independent of the viewing location of the operator.

In a further embodiment the transparent or partially transparent display screen is a transparent or partially transparent OLED (Organic Light-Emitting Diode). In a still further embodiment the transparent display is an LCD (liquid crystal display).

A further embodiment provides a method for viewing multiple aspects of a target object. The method includes capturing a tomographic image of the target object; displaying the tomographic image onto a transparent or partially transparent display screen such that an operator can directly view the target object through the display screen merged with the tomographic image displayed onto the display screen. The merger is independent of operator viewing location.

### BRIEF DESCRIPTION OF THE FIGURES

FIG. 1 shows an isometric view of a presently preferred embodiment of an imaging device 10 utilizing a two dimensional (2D) ultrasound transducer 12 capable of taking a B-Mode image slice 14 of a target object 16. In FIG. 1, there is a two dimensional ultrasound transducer 12 attached to a rigid frame 18. This transducer 12 is preferably a conventional ultrasound transducer that captures a “sonic” tomographic image slice 14 of the interior portion of the target object 16 (in this case a human patient) Extending vertically from the middle region of the rigid frame 18 is a partially transparent OLED 20. The partially transparent OLED 20 allows the user 22 (e.g., a doctor) to look through the partially transparent OLED 20 at a target object 16 (e.g., a patient) while seeing the imaging on the partially transparent OLED 20. The view direction 22 is also indicated. An optional adjustable light 24 is shown. Although a wired embodiment is shown, wireless embodiments are also contemplated.

FIG. 2 shows an isometric view of an additional embodiment of an imaging device 24 using a two-dimensional tomographic transducer 24. The device further includes a viewscreen 26 that superimposes the image from the transducer with an image from a video camera 28, thereby producing an image that simultaneously shows both the tomographic image and an image of a target object.

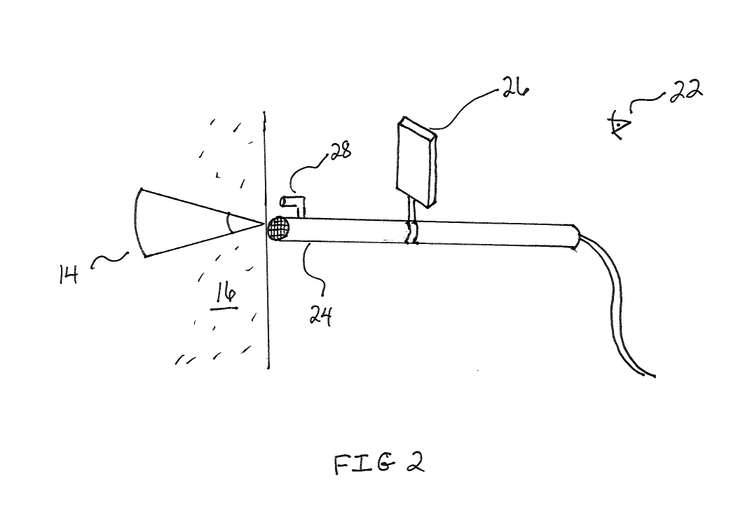

### DETAILED DESCRIPTION OF THE INVENTION

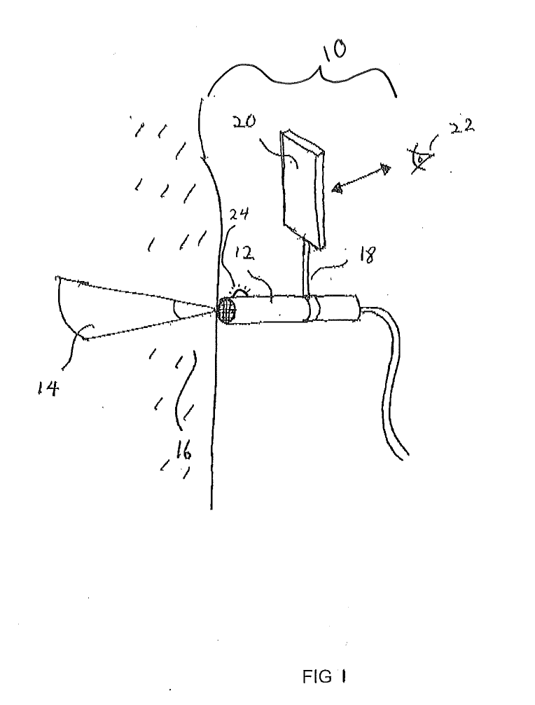

Embodiments of the invention may utilize transparent or semi-transparent screens to display a captured image of a target object, where the image the image is superimposed over the target object. This allows normal human vision to view two aspects of a target object. Typically these aspects are the interior of a target object and the normally-visible exterior. However, other embodiments can be envisioned, including where one layer of the interior of the target object is superimposed over another layer of the target object. A typical embodiment is shown in FIG. 1.

In typical embodiments the image is superimposed over the target object by displaying the image on a transparent or semitransparent screen. The screen may be aligned with the object. In preferred embodiments the screen in a transparent or semi-transparent organic light-emitting diode, or “OLED.” Transparent OLEDs typically have only transparent components (substrate, cathode and anode) and, when turned off, are up to 85 percent as transparent as their substrate. When a transparent OLED display is turned on, it allows light to pass in both directions. A transparent OLED display can be either active- or passive-matrix. This technology can be used for heads-up displays. Many types of OLED may be used. One type of useful transparent OLED is an AMOLED, or “active matrix” OLED.

In some embodiments the transparency of the screen may be varied, either dynamically at the choice of the user or initially at the time of creation of the device. This allows the person using the device to place various degrees of prominence on the outside or inside view of the object that is being examined. By “partially transparent” or “semi-transparent” it is meant that the screen is about 85% transparent. Other embodiments may use screens that are between 30-95% transparent, 50-90% transparent, 70-90% transparent, or 80-90% transparent.

In some embodiments the image is obtained using a tomography device. The tomography device will typically include a suite of electronics for operating the device and collecting data. For example, the tomography device may be an ultrasound. The device may include a scanning handset to which the OLED is attached. The handset may, in turn, be connected to a computer or other processing or storage device. Connection of a handset to a base unit may be either wired or wireless. The handset may include a storage capability. This may allow it to retain images or to display a template or guide on the screen as the practitioner works. In some embodiments the unit is entirely encompassed by a single self-contained, handheld unit.

In at least one preferred embodiment, the present invention provides a two-dimensional ultrasound transducer and an image display that is generally displayed between the target object and human vision. The movement of the ultrasound transducer may be accomplished through direct manipulation by an operator or with the use of one or more robotic arms.

The device may be used with various types of imaging modalities including but not limited to ultrasound, CT, SPECT, PET, OCT, breast thermography, and MRI. The image capture device and the display may or may not be fixed to each other. If not fixed, the imaging device may provide a compensation device that adjusts the image on the display to account for any change in the image capture device orientation or location. Changes may be made relative to the expected viewing angle of a user or observer, or based on the general orientation of the imaging device.

Although embodiments of the invention are typically given medical applications, they may be useful anywhere a handheld tomographic device may be useful. This includes fields as diverse as archaeology and materials science.

The inexpensive nature of an OLED may make them superior for use in sterile environments. For example, a suitable OLED may be printed, sterilized, and used in a single procedure, then detached from the imaging device and discarded. In a further embodiment the display screen is a transparent liquid crystal display (LCD). In still further embodiments the display screen is an organic light emitting transistor (OLET), an interferometric modulator display (for example the iMOD® display from Mirasol), active-matrix organic light-emitting diode (AMOLED), electroluminescent display, time-multiplexed optical shutter (TMOS), dynamic message sign (DMS), quantum dot display (QD), quantum dot-liquid crystal display (QD-LCD), or similar display that will allow superimposition of an image on a transparent display.

In a further embodiment the display screen is touch-sensitive. This allows a user of the device to make notations on the display screen that may be output to an additional display or saved in computer memory. Touch screen functionality may also be used to operate the device.

In a further embodiment the device includes a back light system. Preferably the light is placed between the screen and the patient. Adjustment of this light allows an operator of the device to balance the tomographic image and the image of the patient's body as viewed through the display. This balance may be achieved, for example, by using the light to adjust the reflectivity and brightness of the patient's body. This may be done by a user or automated. Automated embodiments will typically include at least one brightness sensor. Through use of this embodiment the device may provide an optimized display balance in varying lighting conditions.

In a still further embodiment the display and the body of the device include positional encoding capabilities. This allows the system to adjust the position of the tomographic image to account for changes in the position of the device relative to the body of the patient as the display angle or position of the device is changed. In some embodiments the device may include at least one of a gyroscopic sensor and a three-axis accelerometer. This facilitates correlation of the angular position of the device to the position of the patient and the image. This allows accurate placement of the image at the correct location of the device relative to the patient's body. In this way automatic image positioning may be accomplished.

In a further embodiment the viewscreen does not need to be transparent. Instead, the device includes a camera mounted to view an image of the area of the patient that is being subjected to tomographic review. The image gathered by the camera is then merged with the tomographic data and presented on a screen that is not transparent. Those types of screens that have been previously recited would be suitable for use in such an embodiment.

We claim:

1. An imaging device comprising:
an image capture device for capturing an image of the internal structure of a target object; and
a transparent or partially transparent display screen displaying the captured image oriented to an operator of the imaging device such that captured image is superimposed over a direct view of the target object.

2. The partially transparent display screen of claim 1, wherein said display screen is selected from the group consisting of an OLED (Organic Light-Emitting Diode) and an LCD (Liquid Crystal Display).

3. The imaging device of claim 1, wherein said display screen is selected from the group consisting of an organic light-emitting diode (OLED), organic light emitting transistor (OLET), interferometric modulator display, active-matrix organic light-emitting diode (AMOLED), electroluminescent display, time-multiplexed optical shutter (TMOS), dynamic message sign (DMS), quantum dot display (QD), liquid crystal display (LCD), and quantum dot-liquid crystal display (QD-LCD).

4. The imaging device of claim 3, wherein said display screen is an OLED screen.

5. The imaging device of claim 1, further comprising a light source disposed to illuminate said display screen, wherein said light source balances light levels of the captured image and the direct view of the target object.

6. The imaging device of claim 1, wherein said light source is a backlight.

7. The imaging device of claim 1, wherein the image capture device is attached directly to the display screen.

8. The imaging device of claim 1, wherein said image capture device is handheld.

9. The imaging device of claim 1, further comprising positional encoding capability permitting the imaging device to adjust dynamically a position of the captured image relative to a position of the target object as a display angle of the device relative to the target object is changed.

10. The imaging device of claim 9, wherein said positional encoding capability is selected from the group consisting of at least one gyroscopic sensor and a 3-axis accelerometer.

11. The imaging device of claim 1, wherein said display screen is a single-use, disposable screen.

12. A method for viewing a target object, comprising the steps of:
capturing an image of the target object;
displaying said image onto a partially transparent display screen such that an operator can directly view the target object through said partially transparent display screen, wherein the displayed image is superimposed onto the directly viewed image of the target object.

13. The method of claim 12, wherein said image is a tomographic image.

14. The method of claim 12, wherein said image is a tomographic image prepared from a tomographic procedure selected from the group consisting of CT, MRI, SPECT, PET, ultrasound, OCT, and breast thermography.

15. An imaging device comprising:
an image capture device for capturing an image of the internal structure of a target object;
a video capture device for capturing an image of the external features of the target object; and
a display screen simultaneously displaying the captured image of the internal structure and the captured image of the external features, thereby allowing an operator to appreciate both views in a single display.
